(19) United States
(12) Patent Application Publication
(10) Pub. No.: US 2008/0228816 A1
(43) Pub. Date: Sep. 18, 2008

(54) Electronic planner for the caretakers of infants

(76) Inventor: Maxwell R. Wahl, Austin, TX (US)

Correspondence Address: Stephen R. Greiner, Esquire;GREINER LAW OFFICES, P.C., Suite 110, 6701 Democracy Blvd., Bethesda, MD, 20817, US

(21) Appl. No.: 11/723,055

(22) Filed: Mar. 16, 2007

(51) Int. Cl. G06F 17/30

(52) U.S. Cl. 707/104.1; 707/E17.005

(57) ABSTRACT

An electronic planner for the caretakers of infants. The planner includes a central processing unit (CPU) and a digital memory connected to the CPU. A bar code reader is connected to the CPU for gathering reference numbers from bar code symbols that direct the CPU to files stored in the digital memory. A keypad is connected to the CPU for delivering variable data to the CPU that is acted upon by the files withdrawn from the digital memory. A liquid crystal display (LCD) is connected to the CPU for showing information accessed from the digital memory, input via the keypad, or developed by the CPU. Information shown on the display can range describe events ranging from feeding, nursing, medicating, and sleeping, to diaper changing.

### FIELD OF THE INVENTION

The present invention relates generally to electrical digital computers combined with diverse art devices.

### BACKGROUND OF THE INVENTION

Caregivers for infants born prematurely or with serious medical conditions typically maintain records of significant events in the lives of their charges. Such events can include feeding, sleeping, medicating, and excreting. Careful analysis of these events permits caregivers to monitor progress, take appropriate actions to reach growth milestones, analyze setbacks, avoid repetition of actions, and minimize the risk of injury to an infant.

Pen and paper are almost universally employed by medical professionals and others to generate the records that monitor infant progress. Pen and paper, while inexpensive and intuitive to use, have drawbacks, however. Both are easily lost in the equipment that often surrounds a sick infant. Also, paper records can be hard to interpret, especially when information is tracked on different sheets over a long period of time. Finally, paper records can be difficult to edit in a manner that does not confuse future readers of the records.

Some infant caregivers have considered using personal computers to maintain infant records. While being an improvement over pen and paper, personal computers are generally too bulky and loaded with extraneous features to make them practical for infant monitoring purposes. Furthermore, personal computers, with their large keyboards, are especially difficult to keep clean and dry and can serve as a pathway for transmitting germs to an infant.

### SUMMARY OF THE INVENTION

In light of the problems associated with the normal method of tracking the events in the life of an infant with pen and paper, it is a principal object of the invention to provide an electronic planner for the caretakers of infants that keeps accurate and concise records of infant progress. Specifically, the planner monitors: amounts of formula consumed, time spent breastfeeding, numbers of diapers changed, medications administered, and periods of sleep. Use of the planner fully eliminates the need for handwritten records.

It is another object of the invention to provide an electronic planner of the type described that is battery operated, portable, and compact in size—capable of being held in the hand of a user. Thus, the planner can be easily transported, if needed, to doctor's appointments in a purse, diaper bag, or large shirt pocket.

It is a further object of the invention to provide an electronic planner of the type described that automatically records the time at which data is entered therein. An automatic time entry can be easily overridden with the push of a button, however.

Still another object of the invention is to provide an electronic planner of the sort described that is easy and intuitive to operate thereby requiring minimal training on the part of users. Babysitters and nannies, inexperienced in the use of the planner, can provide detailed infant care records to parents with minimal effort.

It is an additional object of the invention to provide an electronic planner of the type described that utilizes bar codes for fast, easy and accurate data entry. In a hospital setting, the use of bar codes increases efficiency by permitting health care professionals to visit more patients during their workdays.

It is an object of the invention to provide improved features and arrangements thereof in an electronic planner for the purposes described that is lightweight in construction, inexpensive to manufacture, and fully dependable in use.

Briefly, the electronic planner in accordance with this invention achieves the intended objects by featuring a central processing unit (CPU) and a digital memory connected to the CPU. A bar code reader is connected to the CPU for gathering reference numbers from bar code symbols that direct the CPU to files stored in the digital memory. A keypad is connected to the CPU for delivering variable data to the CPU that is acted upon by the files withdrawn from the digital memory. A liquid crystal display (LCD) is connected to the CPU for showing information accessed from the digital memory, input via the keypad, or developed by the CPU. A sound generator, also connected to the CPU. serves to alert users at preset times.

The foregoing and other objects, features, and advantages of the present invention will become readily apparent upon further review of the following detailed description of the planner illustrated in the accompanying drawings.

### BRIEF DESCRIPTION OF THE DRAWINGS

The present invention may be more readily described with reference to the accompanying drawings, in which:

FIG. 1 is a top view of an electronic planner for the caretakers of infants in accordance with the present invention.

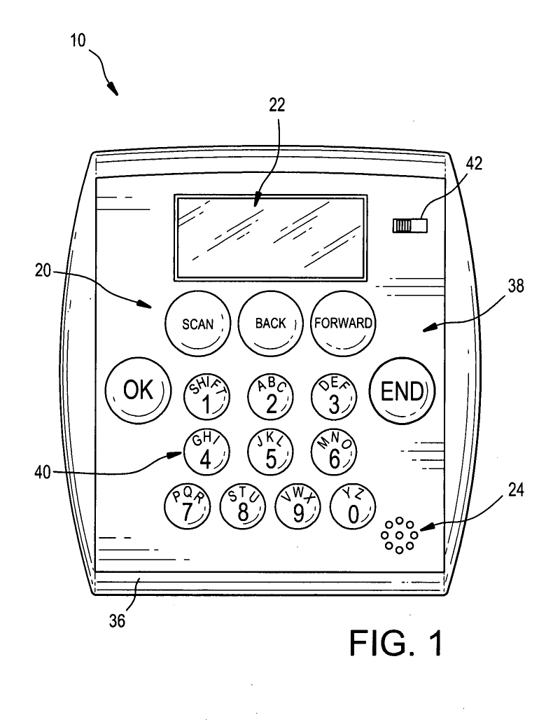

FIG. 2 is a bottom view of the planner of FIG. 1.

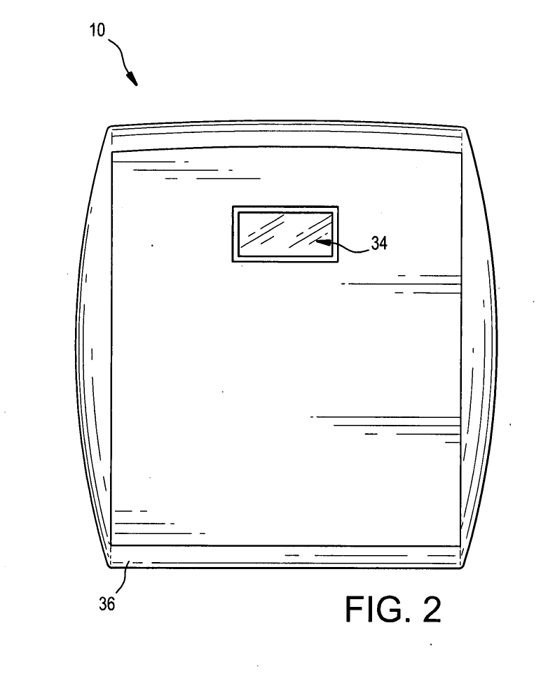

FIG. 3 is a diagrammatic view of the planner.

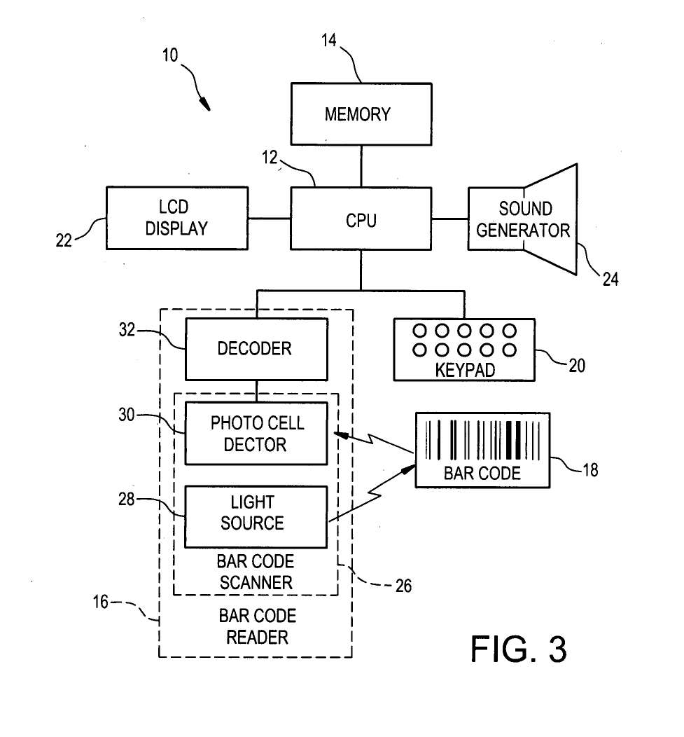

Similar reference characters denote corresponding features consistently throughout the accompanying drawings.

### DETAILED DESCRIPTION OF THE PREFERRED EMBODIMENT

Referring now to the FIGS., an electronic planner in accordance with the present invention is shown at 10. Planner 10 includes a central processing unit (CPU) 12 and a digital memory 14 connected to CPU 12. A bar code reader 16 is connected to CPU 12 for gathering reference numbers from bar code symbols 18 that direct CPU 12 to files stored in memory 14. A keypad 20 is connected to CPU 12 for delivering variable data to CPU 12 that is acted upon by the files withdrawn from memory 14. CPU 12 is also connected to an LCD display 22 that shows information accessed from memory 14, input via keypad 20, or developed by CPU 12. CPU 12 is also connected to a sound generator 24 that serves to alert users at preset times.

CPU 12 is a conventional microprocessor within which is held a software program for monitoring the activities of an infant. To use the program, a reference number found in a bar code symbol 18 must be provided to CPU 12 via bar code reader 16. The reference number determines whether the program will access files stored in memory 14 associated with either: feeding, sleeping, diaper changing, medicating, or setting an alarm. When CPU 12 is energized, a prompt for a reference number from reader 16 appears on LCD display 22.

Bar code symbol 18 is a series of vertical lines whose width and spacing vary. Different combinations of lines and spaces represent different reference numbers. A reference number, perhaps just a single digit in length, is used by CPU 12 to look up files in memory 14 that contain pertinent information associated with feeding, sleeping, diaper changing, medicating, or setting an alarm. Once the designated files have been found, they are withdrawn from memory 14 and handled by CPU 12 in a manner described more fully below. Suitable bar code symbols 18 can be applied to reference cards, notebook pages, and medicine bottles for access to the users of planner 10.

Bar code reader 16 determines which reference number is indicated by a bar code symbol 18 and transmits that number to CPU 12. Reader 16 includes a bar code scanner 26 with a light source 28 and a photocell detector 30 as well as a decoder 32. When symbol 18 is moved past light source 28, light is absorbed by the dark lines and is reflected by the light spaces to detector 30. Detector 30 receives the reflected light and converts such into electrical signals with durations determined by the width of the spaces and lines found in symbol 18. The signals are deciphered by decoder 32 into the reference number that symbol 18 represents. The reference number is then passed to CPU 12 in a traditional data format.

Bar code reader 16 is preferably attached through the keyboard interface to CPU 12 so that decoder 32 can send a reference number in key codes exactly as though the number had been typed into keypad 20. Reader 16, therefore, is a “wedge reader” since it is connected between a keypad 20 and a CPU 12 and operates as a second keyboard. CPU 12 receives the reference number from reader 16 in the same manner in which it would have been produced on keypad 20 by a fast typist.

Light source 28 is a laser capable of projecting a moving beam of light that sweeps back and forth across a bar code symbol 18. The beam of light can be accurately reflected several inches to detector 30 positioned adjacent light source 28 behind a transparent window 34 in the back of a housing 36. Unsuccessful readings of symbol 18 go unnoticed by a user of planner 10. Once a number from symbol 18 has been successfully transmitted to CPU 12, however, light source 28 is deenergized by CPU 12, requiring a user to press a button 38 on keypad 20 marked with the indicia SCAN to reenergize light source 28.

Keypad 20 permits information to be input into CPU 12 and directs the manner in which the information is processed. Keypad 20 can be of membrane-type for water resistance. Keypad 20 has ten keys 40 marked with indicia that designate 1/SHIFT, 2/A/B/C, 3/D/E/F, 4/G/H/I, 5/J/K/L, 6/M/N/O, 7/P/Q/R, 8/S/T/U, 9/V/W/X, and 0/Y/Z. Keypad 20 also has five buttons 38, each of which being respectively marked with indicia that designate SCAN, BACK, FORWARD, OK, and END functions within CPU 12. By pressing keys 40, a user can input information into CPU 12. However, by pressing buttons 38, a user can cause CPU 12 to operate upon information input with keys 40.

Keys 40 permit alphanumeric characters to be entered into CPU 12. For example, pressing the 1/SHIFT key once causes the numeral “1” to appear on display 22. Pressing the 1/SHIFT key a second time, however, causes the numeral “1” to disappear from display 22 and causes the shift function within CPU 12 to be activated. The shift function permits the input of one of several alphanumeric characters when one of the other keys 40 is pressed. In this regard, engaging the shift function by pressing the 1/SHIFT key twice and, then, pressing the 2/A/B/C key twice causes the letter “A” to appear and remain in display 22 for entry into CPU 12. Likewise, pressing the 2/A/B/C key three times after engaging the shift function causes the letter “B” to appear in display 22 for entry into CPU 12. Additionally, pressing the 2/A/B/C key four times after engaging the shift function causes the letter “C” to appear in display 22 for entry into CPU 12. Finally, pressing the 2/A/B/C key without engaging the shift function causes the numeral “2” to appear in display 22 for entry into CPU 12. The remaining keys 40 are similarly operated to input alphanumeric characters into CPU 12, and by engaging the shift function in combination with the other keys 40, words and numbers having multiple digits can be input into CPU 12.

Pressing buttons 38 causes CPU 12 to perform work. As was noted above, pressing the button 38 marked SCAN causes the energization of light source 28 in bar code reader 16 and places CPU 12 in a mode whereby it actively waits for a signal from decoder 32. Additionally, pressing either of the buttons 38 marked BACK or FORWARD causes a cursor (not shown) on display 22 to move, respectively, to the left or right across display 22. By pressing the button 38 marked OK, CPU 12 is instructed to perform an operation, indicated by a reference number derived from the last scanned bar code symbol 18, upon information previously entered into CPU 12 by pressing appropriate keys 40 and to show the results of the operation in display 22. Finally, pressing the button 38 marked END removes from display 22 any alphanumeric characters shown there and terminates the previously performed operation. CPU 12 automatically transfers all information entered into CPU 12 via keys 40 to memory 14 for subsequent retrieval.

LCD display 22 is connected to CPU 12 and permits a user to visually confirm the selected parameters under which planner 10 operates. Display 22 presents ten lines of thirty characters for optimum data transmission to a user. Display 22 can be backlit for nighttime viewing.

Use of planner 10 begins with a user energizing CPU 12 by sliding ON/OFF switch 42 to the “on” position and delivering some basic information to CPU 12. Upon energizing CPU 12, display 22 is caused by CPU 12 to prompt the user to input the name of an infant by showing “Infant's Name:_”. After the user completes this task by pressing the appropriate keys 40 as described above, she presses the button 38 marked OK to show the infant's name on the first line of display 22. Now, display 22 is caused by CPU 12 to prompt the user to input the date of birth of the previously named infant by showing “DOB (**/**/**):”. After the user presses the appropriate keys 40 to enter the correct date, she presses the button 38 marked OK to show this date on the second line of display 22 beneath the infant's name. Next, display 22 is caused by CPU 12 to prompt the user to input the name of the infant's pediatrician by showing “Doctor's Name:_”. Once again, after pressing the appropriate keys 40 and the OK button, the pediatrician's name is shown on the third line of display 22. Finally, display 22 is caused by CPU 12 to prompt the user to input the telephone number of the infant's pediatrician by showing “Doctor's Tel. # (***-***-****):_”. After pressing the appropriate keys 40 and the OK button, the telephone number is shown on display 22 adjacent the pediatrician's name.

Planner 10 monitors the volume of formula or breast milk that an infant consumes from a bottle as well as the time at which it was consumed. To do this, a user first presses the button 38 marked SCAN to energize bar code reader 16 and then draws a bar code symbol 18 indicating that the infant is bottle-fed past light source 28. Reader 16, then, automatically extracts the reference number from symbol 18 at transmits such to CPU 12. In response, CPU 12 withdraws from memory 14, and executes, a file that causes display 22 to prompt the user to scan another bar code symbol 18 indicating the volume of formula or breast milk consumed from a bottle by showing “Waiting for scan to input information” on the bottom line of display 22. Then, the user presses the button marked SCAN and scans a symbol 18 indicating the volume consumed (separate symbols 18 corresponding to volumes ranging from 1-8 oz. are provided) with reader 16 so that another reference number is conveyed to CPU 12 by reader 16. With this second reference number, CPU 12 extracts a file from memory 14 corresponding to the volume consumed, say 6 oz., and shows such on display 22 with the current time, for example 1:00 pm, as “6 OZ, 1:00 PM”. If this information is correct, the user presses the button 38 designated END to save it in memory 14 where it can be recalled as described below to offer daily and weekly totals of liquids consumed from bottles.

Planner 10 monitors the amount of time that an infant spends nursing. To do this, a user first presses the button 38 marked SCAN to energize bar code reader 16 and, then, draws a bar code symbol 18 indicating that the infant is nursing past light source 28. Reader 16, then, automatically extracts the reference number from symbol 18 at transmits this to CPU 12. In response, CPU 12 withdraws from memory 14, and executes, a file that causes display 22 to prompt the user to scan another bar code symbol 18 indicating which breast(s) are being accessed by the infant during feeding by showing “Scan right, left or combination bar code” on the bottom line of display 22. Then, the user presses the button 38 marked SCAN and scans a symbol 18 indicating the breast(s) used for the feeding (separate symbols 18 corresponding to left, right, and both are provided) with reader 16 so that another reference number is conveyed to CPU 12 by reader 16. With this reference number, CPU 12 withdraws from memory 14, and executes, a file that times the period until the user presses the button marked END to indicate that a feeding has concluded and causes display 22 to prompt the user to press the button marked END when the period of feeding has ended by showing “Feeding Mode” on the bottom line of display 22. When feeding stops, the user presses the END button to signal CPU 12 to cease timing the feeding and to add this new period to any others accumulated that day indicated in the file withdrawn from memory 14. The new total is automatically transmitted by CPU 12 to memory 14 where it can be recalled as described below to offer daily and weekly nursing totals.

Planner 10 keeps track of diaper changes. To do this, a user first presses the button 38 marked SCAN to energize bar code reader 16 and, then, draws past light source 28 a bar code symbol 18 indicating that the infant has had his diaper changed. Reader 16, next, automatically extracts the reference number from symbol 18 at transmits such to CPU 12. In response, CPU 12 withdraws from memory 14, and executes, a file that causes display 22 to prompt the user to scan another bar code symbol 18 indicating whether the infant either urinated, defecated or had diarrhea prior to the diaper change by showing “Scan specific bar code” on the bottom line of display 22. Then, the user presses the button marked SCAN and scans, with reader 16, a symbol 18 indicating the type of excretion found in the diaper (bar code symbols 18 corresponding to urination, normal defecation, and diarrhea are provided) and an additional reference number is conveyed to CPU 12. With this reference number, CPU 12 withdraws from memory 14, and executes, a file that automatically records in memory 14 the time at which the diaper was changed in addition to the contents of that particular diaper. Furthermore, CPU 12 generates new totals of the number of diapers changed during that day and the previous week and totals of the diaper contents and automatically transmits these results to memory 14 where they can be recalled as described below to offer daily and weekly diaper change totals.

Planner 10 tracks periods of sleep of an infant. Here, a user first presses the button 38 marked SCAN to energize bar code reader 16 and, then, draws a bar code symbol 18, indicating that the infant is sleeping, past light source 28. Reader 16, now, automatically extracts the reference number from symbol 18 and transmits it to CPU 12. In response, CPU 12 withdraws from memory 14, and executes, a file that times the period until the user presses the button marked END to indicate that the infant is awake and causes display 22 to prompt the user to press the button marked END when the period of sleep has ended by showing “Sleep Mode” on the bottom line of display 22. When the infant awakens, the user presses the END button to signal CPU 12 to cease timing the period of sleep and to add this new period to any others accumulated that day in the file withdrawn from memory 14. The new total is automatically transmitted by CPU 12 to memory 14 where it can be recalled as described below to offer daily and weekly sleep totals.

Planner 10 monitors the medications administered to an infant. To do this, a user first presses the button 38 marked SCAN to energize bar code reader 16 and, then, draws a bar code symbol 18, indicating that medicine has been given to the infant, past light source 28. Reader 16, then, automatically extracts the reference number from symbol 18 and transmits such to CPU 12. In response, CPU 12 withdraws from memory 14, and executes, a file that causes display 22 to prompt the user to scan another bar code symbol 18 indicating the name of the medicine administered by showing “Scan a specific medicine bar code” on the bottom line of display 22. Then, the user presses the button marked SCAN to reenergize bar code reader 16 and scans a symbol 18 indicating the medicine administered (five symbols 18 corresponding to five different medicines are provided with planner 10 though this number is a matter of design choice). Reader 16 automatically conveys to CPU 12 a reference number that corresponds to the scanned symbol 18 which is used by CPU 12 to extract a file from memory 14 corresponding to the administered medicine and to cause display 22 to prompt the user to input the administered medicine dosage with the keypad 20 by showing “Type dosage into keypad” on the bottom line of display 22. When the user enters a dosage of, say, 100 mg., by pressing appropriate keys 40 and presses the button 38 marked OK, CPU 12 causes display 22 to show a generic name for the administered medicine together with the dosage and the current time. For example, the bottom line of display 22 might show “Medicine A, 100 MG, 3:00 AM” in response to signals from CPU 12. If this information is correct, the user presses the button 38 designated END to save the information in memory 14 where it can be recalled as described below to offer reports that track the medicating of the infant.

Planner 10 can be employed to remind a user of an upcoming event of importance. For example, a user first presses the button 38 marked SCAN to energize bar code reader 16 and, then, draws a bar code symbol 18, indicating that the user intends to use the alarm function, past light source 28. Reader 16, now, extracts the reference number from symbol 18 and transmits it to CPU 12. In response, CPU 12 withdraws from memory 14, and executes, a file that causes display 22 to prompt the user to scan another bar code symbol 18 indicating the type of reminder desired by showing “Scan a specific bar code” on the bottom line of display 22. Afterward, the user presses the button marked SCAN to reenergize bar code reader 16 and scans a symbol 18 indicating the reminder type (five symbols 18 corresponding to five different reminders, e.g., diaper change, bottle feed, breastfeed, medicate, and awaken from sleep, are provided with planner 10 though this number is a matter of design choice). Reader 16 automatically conveys to CPU 12 a reference number that corresponds to the scanned symbol 18 that is used by CPU 12 to obtain information from the file just extracted from memory 14 that prompts the user to input the time at which she wishes an audible alarm to sound by showing “Type reminder time” on the bottom line of display 22. When the user enters a time of, say, 1:00 PM, by pressing appropriate keys 40 and presses the button 38 marked OK, CPU 12 causes display 22 to show the type of reminder desired by the user and its set time. For example, the bottom line of display 22 might show “1:00 AM, Medicine” in response to signals from CPU 12. If this information is correct, the user presses the button 38 designated END to save the information in memory 14 where it can be recalled later and to cause CPU 12 to energize audible alarm or sound generator 24 when the set time is reached. When audible alarm 24 sounds, a user turns it off simply by pressing the button 38 marked END.

Planner 10 can provide a variety of reports on display 22 for monitoring the health of an infant. A user first presses the button 38 marked SCAN to energize bar code reader 16 and, then, draws one of the six bar code symbols 18, used to initiate the functions noted above, past light source 28. Reader 16, next, extracts the reference number from the symbol 18 indicating either that: 1) the infant is bottle fed, 2) the infant is breast fed, 3) the infant is sleeping, 4) the infant is being medicated, 5) the diaper of the infant has been changed, or 6) a reminder has been set, and transmits it to CPU 12. In response, CPU 12 extracts from memory 14, and executes, the file associated with the reference number just entered into it. Now, the user presses the button 38 marked OK to cause CPU 12 to show a report on display 22 that is associated with the function that interests the user.

The reports generated by planner 10 differ by topic. With respect to bottle feedings, for example, the report consists of two columns with the first indicating the times at which bottle feedings started and the other indicating the volumes of liquids ingested by the infant with the cumulative volume being provided at the bottom of the second column. Breastfeeding is tracked in a report of four columns with: the first column recording the times of the feedings, the second column recording the duration of the feedings with the cumulative feeding time being provided at the bottom of the second column, the third column indicating, by means of a check mark, whether the feeding was associated with the right breast, and the fourth column indicating, by means of a check mark, whether the feeding was associated with the left breast. Periods of sleep are recorded in the same manner as bottle feedings with two columns, one indicating the times at which periods of sleep started and the other indicating the duration of the sleep period with a running total being provided at the bottom of the second column. Diaper changes are described in reports that are four columns wide with: the first column displaying the times at which diaper changes were initiated, the second column indicating by a check mark whether the infant urinated with a running total of urination events being provided at the bottom of the column, the third column indicating by a check mark whether the infant defecated with a running total of defecations being provided at the bottom of the column, and the fourth column indicating by a check mark whether the infant had diarrhea with a running total being provided at the bottom of the column. Administrations of medications are tracked in reports that are three columns wide with: the first column recording the time at which the medicine was administered to the infant, the second column indicating the code name of the administered medicine, and the third column showing the dosage of the administered medicine. Finally, a report indicating the alarms that have been set within planner 10 to alert a user of important events can be found to contain two columns with the first showing the time at which the audible alarm will sound and the other indicating the type of reminder being made, i.e., administer medicine, change diaper, etc. Periods of time tracked in the reports can span the previous day or week.

All reports are provided with a heading with basic information about the infant. This information was originally keyed into planner 10 at the beginning of its use. This information includes the infant's: name, date of birth, pediatrician, and pediatrician's telephone number.

From the foregoing, it will be appreciated that a user of planner 10 can move around her environment with an infant either in hand or relatively remote while scanning, keying data, and getting responses, some audible, from planner 10 when needed. Thus, it is believed that once an individual adopts planner 10 as a primary tool for monitoring the events in the life of an infant, she will never voluntarily choose to return to pen and paper to accomplish the same task.

While planner 10 has been described with a high degree of particularity, it will be appreciated by those skilled in the art that many modifications can be made to it. For example, various buttons 38 can be added to keypad 20 that function to assist a user in the editing, moving, copying, modifying and deleting the information within CPU 12 and memory 14 but, as these are well-known word processing and spreadsheet functions they have, in the interest of making this specification reasonably brief, not been delineated. Therefore, it is to be understood that the present invention is not limited merely to planner 10 described herein, but encompasses any and all planner embodiments within the scope of the following claims.

I claim:

1. An electronic planner, comprising:
a central processing unit;
a digital memory being connected to said central processing unit;
a bar code reader being connected to said central processing unit for gathering reference numbers from bar code symbols that direct said central processing unit to files stored in said digital memory;
a keypad being connected to said central processing unit for delivering variable data to said central processing unit that is acted upon by the files withdrawn from said digital memory; and, a liquid crystal display being connected to said central processing unit for showing information accessed from said digital memory, input via said keypad, or developed by said central processing unit.

2. An electronic planner, comprising:
a central processing unit;
a digital memory being connected to said central processing unit;
a bar code reader being connected to said central processing unit for gathering reference numbers from bar code symbols that direct said central processing unit to files stored in said digital memory;
a keypad being connected to said central processing unit for delivering variable data to said central processing unit that is acted upon by the files withdrawn from said digital memory;
a liquid crystal display being connected to said central processing unit for showing information accessed from said digital memory, input via said keypad, or developed by said central processing unit; and,
a sound generator being connected to said central processing unit for producing an audible sound on command from said central processing unit.

3. An electronic planner, comprising:
a central processing unit;
a digital memory being connected to said central processing unit;
a keypad being connected to said central processing unit for delivering variable data to said central processing unit that is acted upon by the files withdrawn from said digital memory;
a bar code reader being connected as a wedge reader to said central processing unit for gathering reference numbers from bar code symbols that direct said central processing unit to files stored in said digital memory;
a liquid crystal display being connected to said central processing unit for showing information accessed from said digital memory, input via said keypad, or developed by said central processing unit; and,
a sound generator being connected to said central processing unit for producing an audible sound on command from said central processing unit.
